(19) United States
(12) Patent Application Publication
(10) Pub. No.: US 2021/0218261 A1
(43) Pub. Date: Jul. 15, 2021

(54) SYSTEM AND METHOD FOR SOLAR CHARGING OF PORTABLE ELECTRONIC DEVICES

(71) Applicant: Optivolt Labs, Inc., Burlingame, CA (US)

(72) Inventors: Daniel Kofman, Burlingame, CA (US); Paul Couston, Burlingame, CA (US); Rohit Kalyanpur, Burlingame, CA (US); Sriram Raghu, Burlingame, CA (US)

(21) Appl. No.: 17/146,212

(22) Filed: Jan. 11, 2021

Related U.S. Application Data
(60) Provisional application No. 62/959,503, filed on Jan. 10, 2020.

(51) Int. Cl. H02J 7/00; G05F 1/67

(52) U.S. Cl. CPC H02J 7/00712; H02J 2310/22; H02J 2300/26; G05F 1/67

(57) ABSTRACT

One variation of a system for solar power systems includes: a power storage device; a flexible PCB layer; a photovoltaic cell arranged over the flexible PCB layer; and a power conversion circuit arranged underneath the flexible PCB layer, the system comprising a power stage circuit electrically coupled to the photovoltaic array and to the power storage device through the flexible PCB layer; and a controller electrically coupled to the power stage circuit through the flexible PCB layer and configured to a) measure a power output from the photovoltaic array, b) operate the power stage circuit in an idle mode in response to determining that the power output does not exceed a threshold power output, and c) calculate a maximum power point of the photovoltaic array in response to determining that the power out exceeds the threshold power output.

### CROSS-REFERENCE TO RELATED APPLICATIONS

This application claims the benefit of U.S. Provisional Application No. 62/959,503, filed on 10 Jan. 2020, which is incorporated in its entirety by this reference.

### TECHNICAL FIELD

This invention relates generally to the field of solar power systems and more specifically to a new and useful method for passive solar charging of portable electronic devices in the field of solar power systems.

### BRIEF DESCRIPTION OF THE FIGURES

FIG. 1 is a schematic representation of a first system;

FIG. 2 is a flowchart representation of a method; and

FIG. 3 is a diagram representation of one variation of the method.

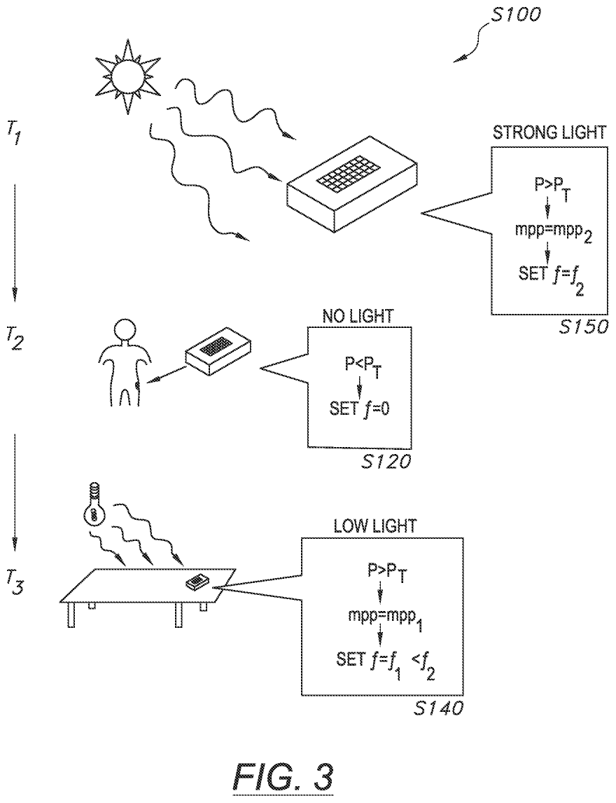

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

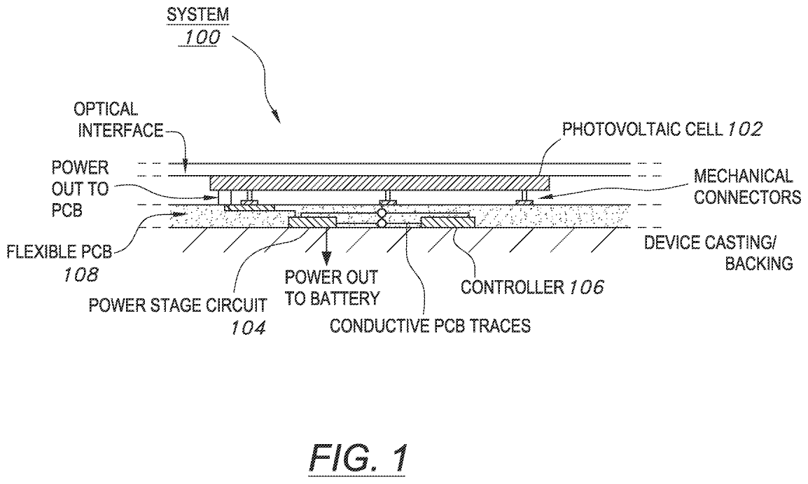

As shown in FIG. 1, a method S100 for solar charging of portable electronic devices at a system includes: a photovoltaic cell; a flexible PCB layer; and a power conversion circuit including a power stage circuit and a controller.

In particular, the method S100 includes measuring a power output from the photovoltaic cell at Block S110. In response to determining that the power output does not exceed a threshold power output, the controller can operate the power stage circuit in an idle mode at Block S120, and, in response to determining that the power out exceeds the threshold power output, calculate a maximum power point of the photovoltaic cell at Block S130. In response to determining that the maximum power point is consistent with a first lighting condition, the controller can output gate control signals to the power stage circuit at a first frequency at Block S140. In response to determining that the maximum power point is consistent with a second lighting condition, the controller can output gate control signals to the power stage circuit at a second frequency greater than the first frequency at Block S150.

### 2. Applications

Generally, the method S100 can be implemented by a system to charge a power storage device (e.g., a battery) in a portable electronic device. In particular, the system includes a photovoltaic (or “PV”) cell and power conversion circuitry, including a power stage circuit and a controller. The photovoltaic cell and power conversion circuitry are arranged on opposite sides of a thin, flexible PCB layer (e.g., between 0.1 mm and 0.5 mm in thickness) to form a solar charging assembly of minimal thickness (e.g., between 0.25 mm and 0.75 mm), which can be integrated into, assembled onto, or deposited on a casing of a portable electronic device (e.g., a smartphone, a tablet, a smartwatch, a laptop computer) and coupled to a battery and/or power management system in this portable electronic device, as illustrated in FIG. 1.

Generally, the portable electronic device moves between a user's pocket, a user's hand, and any number of indoor surfaces and outdoor surfaces throughout a given period of time (e.g., over the course of a day), which may expose the portable electronic device to frequent (e.g., hundreds of instances of per day), rapid (e.g., sub-second timescale), and unpredictable (or erratic, disordered, stochastic) changes in lighting conditions. These frequent, rapid, and unpredictable changes in incident light intensity at the photovoltaic cell may yield significant variations in power output of the photovoltaic cell and efficiency of power conversion between the system and the battery in the portable electronic device. Therefore, the controller can execute Blocks of the method S100 to continuously load-match (e.g., impedance-match) between the photovoltaic cell and the battery (or the power management system in the portable electronic device) at a high, configurable duty cycle frequency, extending transient changes in lighting over many control cycles in order to rapidly (re)configure the system to achieve high output power of the photovoltaic cell (e.g., near a maximum power point of the photovoltaic cell) and thus harvest energy to recharge the battery in the portable electronic device even under frequent, rapid, and unpredictable changes in local lighting conditions.

The controller can also drive switch components on the power stage circuit at high, configurable drive frequency (e.g., 200 kHz to 2 MHz; 2 MHz to 100 MHz) that allows power stage circuit to incorporate small circuit components (e.g., 100-micron-scale inductors, switches, capacitors), thereby enabling thin total stack heights (e.g., less than 0.75 mm). However, the switches and other components in the power stage circuit may exhibit power dissipation (i.e., switching losses) proportional to the controller's drive frequency. For example, at high switching frequencies and under low-light conditions, switches in the power stage circuit may exhibit power dissipation greater than or equal to the power output of the photovoltaic cell. Therefore, the controller can modify its drive frequency and load characteristics of the photovoltaic cell in near real time to match (e.g., proportional to) the current lighting condition and transient lighting changes, thereby: achieving high power conversion efficiency of the photovoltaic cell; limiting a ratio of switching losses to total power harvested by the photovoltaic cell; and enabling net-positive power conversion in low light and under varying lighting conditions. By executing Blocks of the method S100, the system can thus avoid net-zero power conversion in varying lighting conditions and net-negative power conversion (i.e., energy loss) in low-light environments. Because the controller can integrate with power stage components defining small (e.g., 100-micron-scale) physical dimensions, this adjustable drive frequency enables the controller to convert power between the photovoltaic cell and the battery (or power management system in the portable electronic device) while accommodating current throughput limitations of these small power stage components, thereby reducing risk of failure in these components, such as due to over-current incidents during transient local lighting changes.

Because the controller thus enables the small components in the power stage to be assembled on a thin, flexible PCB layer coupled to a photovoltaic cell, the system can be integrated into or deposited on an electronic device with limited impact on the overall thickness of the electronic device. Furthermore, the power stage circuit can convert the variable electrical load output of the photovoltaic cell to a stable, low-voltage output of variable current (e.g., 3.5V, 5V, 12V) directly to the device's charging or power management system.

Alternatively, the power stage circuit can output current directly to a battery in the portable electronic device to recharge this battery. For example, in this implementation, the controller can monitor a charge state of the battery, calculate a target voltage and/or a target current to supply to the battery based on the current charge state of the battery, and adjust load characteristics of the photovoltaic cell output at the power stage according to the target voltage and/or a target current in order to directly recharge the battery without additional power conditioning circuitry between the power stage and battery.

Thus, the systems and method described herein enable efficient solar charging of a portable electronic device in a wide variety of static and changing lighting conditions, such as offsetting the device's battery usage in indoor lighting and enabling significant recharging of the battery in outdoor lighting.

### 3. System

Generally, the system 100 includes a photovoltaic cell 102 and power conversion circuitry 104 electrically coupled to the photovoltaic cell 102. The photovoltaic cell 102 is configured to transform the energy of light incident on its surface into electrical power by the photoelectric effect. The output of the photovoltaic cell 102 typically varies in both voltage and current depending on lighting conditions, temperature of the cell, and other factors. Therefore, the power conversion circuitry 104 is configured to convert the output of the photovoltaic cell 102 to a fixed and stable voltage (e.g., 5V, 12V) and output power to an external power storage device (e.g., a battery on a mobile phone) or an external power management system at this voltage.

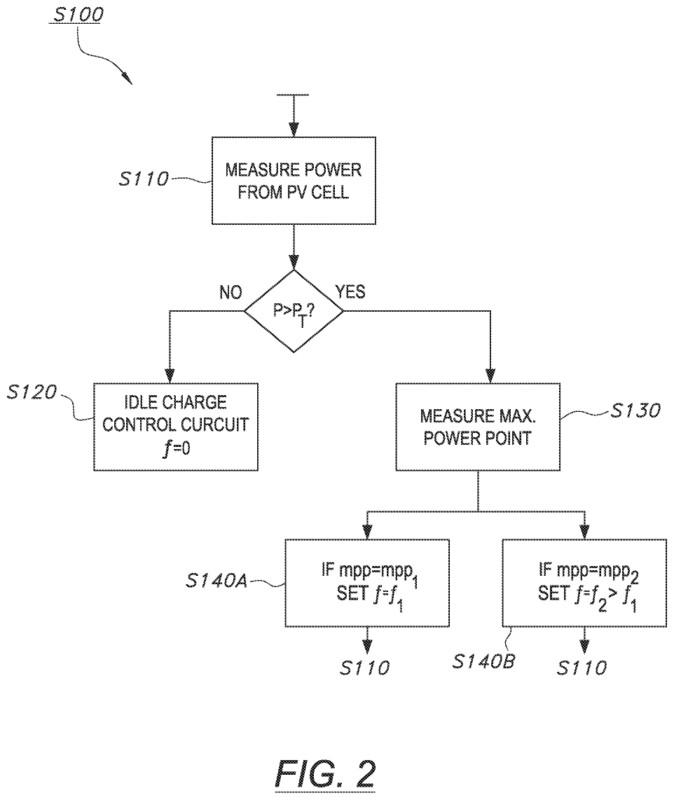

The system 100 also includes a flexible PCB layer 108. As shown in FIG. 2, the photovoltaic cell 102 is arranged over a flexible PCB layer 108 and spans a majority of its upper surface area, enabling the system 100 to harvest energy from a majority of the light incident upon its surface. In one implementation, the photovoltaic cell 102 is deposited directly on the flexible PCB layer 108 and electrically coupled to the power conversion circuitry 104 through the flexible PCB layer 108. In another implementation, the photovoltaic cell 102 is affixed to the flexible PCB layer 108 using screws, spring clips, and/or any other suitable mechanical connectors, which can also form electrical connections between the photovoltaic cell and the flexible PCB layer 108. Power conversion circuitry 104, including power stage circuit 104 and controller 106, is deposited on the opposite side of the flexible PCB layer 108 to form a solar charging assembly that can be integrated into, deposited on, or assembled on a portable electronic device, as shown in FIG. 1.

The controller 106 is a logic device connected to a power stage circuit 104 through electrical traces on the flexible PCB layer 108, such as a microcontroller, FPGA, ASIC or other logic device compatible with a low input voltage (e.g., <3.5V, <5V, <14V) and configured to sample voltage and current values from the photovoltaic cell 102 and to output gate control signals to switches and/or gates in the power stage circuit 104. In particular, the controller 106 is configured to output these control signals at a configurable high frequency and to increase or decrease this drive frequency in near-real time in response to certain conditions (e.g., changes in lighting condition, changes in photovoltaic cell efficiency, overload of power stage circuit components, start-up protocols). In one configuration, the controller operates at a configurable drive frequency between 200 kHz and 2 MHz. In another configuration, the controller operates at a configurable drive frequency between 2 MHz and 100 MHz.

The power stage circuit 104 is configured to convert the photovoltaic cell's variable voltage and current output to a stable output voltage and/or stable output current—despite varying incident light conditions—and to output this stable power signal to a power management system and/or directly to battery in a portable electronic device based on control signals received from the controller 106. Therefore, the power stage circuit 104 and the controller 106 and cooperate to enable solar charging of the electronic device's power storage device (e.g., a battery). In particular, the power stage circuit 104 can include inductors, capacitors, switches (e.g., FETs, MOSFETs) and other circuit components arranged to form a converter between the photovoltaic cell 102 and the power storage device, such as a DC-DC buck converter, DC-DC boost converter, split pi converter, a DC-AC converter, or any other suitable type of converter between the photovoltaic array 102 and the power storage device. These circuit components define physical dimensions that are significantly smaller (e.g., sub-100-micron scale) than conventional power stage components, thereby enabling a small (e.g., 0.25 mm-0.75 mm) total stack size suitable for integrating with a portable electronic device without significantly increasing the device's overall dimensions. The high drive frequency of the controller 104 reduces total electrical load on these small power stage components during power conversion, thereby significantly reducing the risk of component fault (e.g., due to over-current events), even under a wide range of lighting conditions. For example, the power stage components are sized to tolerate an electrical load consistent with the power output of the photovoltaic cell 102 under maximum lighting conditions (e.g., an unobstructed cell in full sunlight) when driven at some minimum frequency (e.g., 1 MHz). In one implementation, the power stage circuit 104 includes small form-factor switches configured for low-voltage operation (e.g., gallium nitride MOSFETs) in order to reduce switching losses when transferring power from the photovoltaic array 102 to the external battery and/or power management system at high gate drive frequencies, as well as to reduce resistive losses between the source and drain terminals of the switch. In one variation, the power stage circuit 104 and the controller 106 are integrated into a single power conversion circuit (e.g., an ASIC) arranged under the flexible PCB layer 108 and configured to execute Blocks of the method S100.

In one implementation, the power stage circuit 104 is configured to convert the variable voltage and current output by the photovoltaic cell 102 to a fixed, configurable low voltage (e.g., 3.5V, 5V, 12V) of varying current and output power to a power management system on the portable electronic device. For example, the power stage circuit 104 can output power to a trace connecting the portable electronic device's charging port and the power management system, which then outputs power to a battery. In another implementation, the power stage circuit 104 is configured to output power directly to a power storage device (e.g., battery) on the portable electronic device, bypassing any power management system. In this implementation, the controller 106 can be configured to continuously sample a charge state of the battery and to adjust the load characteristics (e.g., voltage, current) of the power stage output to match current charging requirements of the battery. For example, the controller 106 can be configured to convert the power stage output to a constant current at varying (e.g., increasing) voltage when initiating charging of the battery (e.g., a Li-ion battery). Upon reaching a saturation charge state, the controller 106 can then maintain the power stage output at a constant voltage (e.g., 4.2V) with varying (e.g., decreasing) current proportional to a charge level of the battery. In response to detecting that the battery is fully charged, or in response to detecting over-voltage, over-current, or over-temperature events, the controller 106 can cease to output drive signals to the power stage circuit 104 in order to stop power conversion between photovoltaic cell 102 and the battery. Controller 106 can likewise be configured to implement other charging protocols for different types of power storage devices (e.g., lead-acid batteries, carbon batteries or other suitable power storage devices) in order to facilitate safe, efficient solar charging.

### 4. Power Measurement and Initiation Conditions

Blocks of the method S100 recite: measuring a power output from a photovoltaic cell at Block Silo, and, in response to determining that the power output does not exceed a threshold power output, operating the power stage circuit in an idle mode at block S120. The controller 106 is generally configured to: continuously or intermittently sample an output current and/or voltage (e.g., power) from the photovoltaic cell 102; compare the output power to a predetermined or configurable threshold power output; and to determine whether to output gate control signals to the power stage circuit 104 (i.e., initiate energy harvest, initiate power conversion) accordingly.

For example, when the system 100 integrates with a smartphone, there may be periods of time, even under strong environmental lighting conditions, when the photovoltaic array 102 receives little to no incident light. For instance, if a user places the portable electronic device in her pocket, the photovoltaic cell 102 may receive enough incident light relative to the power requirements of the power stage circuit 104 and the controller 106 to generate a net-positive power output. The controller 106 is therefore configured to intermittently or continuously sample voltage, current, and/or power output by the photovoltaic cell 102, and to compare these outputs to a minimum threshold voltage, current, and/or power output corresponding to some lowest acceptable lighting condition. For example, this lighting condition is one in which the photovoltaic cell 102 produces as much power as is required to operate control logic, drive switches in the power stage circuit 104, etc. under current lighting conditions (i.e., an energy-neutral or break-even point), accounting for switching losses incurred at FETs and/or other components on the power stage/power stage circuit. The controller 106 is further configured to maintain the power stage circuit in an idle (e.g., low power, undriven) mode if the sampled voltage, current, and/or power output does not exceed a predetermined threshold. While maintaining and/or operating the power stage circuit 104 in the idle mode, the controller 106 does not output gate drive signals to the power stage circuit 104, but can continue to monitor the output of the photovoltaic cell 102. In other words, the controller 106 does not drive the switches (e.g., FETs) in the power stage circuit 104 unless it detects an output from the photovoltaic cell 102 that will result in net-positive power conversion between the photovoltaic cell 102 and a battery. More specifically, the drive frequency of control signals output to switch components on the power stage 106 below a minimum power cutoff (e.g., corresponding to a minimum light intensity or lighting condition) is zero.

Alternatively and/or additionally, the controller 106 can be configured to sample the voltage of a capacitor connected to the photovoltaic cell 102 rather than directly sampling the output of the photovoltaic cell 102. In this implementation, the controller 106 is configured to compare the voltage across the charging capacitor to a threshold voltage corresponding to the lowest acceptable lighting condition discussed above, and to either maintain the power stage circuit in idle mode or initialize power conversion accordingly.

The controller 106 can also be configured to detect a charge level and/or charge state of the device's battery and maintain or transition the power stage circuit 104 to the idle mode accordingly. In one implementation, the controller 106 can transition the power stage circuit 104 to the idle or off mode in response to detecting that the phone battery is fully charged. Additionally and/or alternatively, the controller 106 can transition the power stage circuit 104 to the idle mode in response to detecting that a USB charging device has been plugged into the portable electronic device's charging port and is supplying power to the battery (e.g., by periodically sampling the voltage across the portable electronic device's USB-battery line).

### 5. System Initiation and Maximum Power Point Tracking

Blocks of the method S100 recite, in response to determining that the power out exceeds the threshold power output, the controller can calculate a maximum power point of the photovoltaic cell 102 at block S130. Generally, the controller 106 is configured to: continuously or intermittently sample an output voltage, output current and/or output power from the photovoltaic cell 102; compare these outputs to a minimum power threshold as discussed above; initiate power conversion between the photovoltaic cell 102 and an external battery or power storage device at the power stage circuit 104 in response to measuring an output from photovoltaic cell 102 that exceeds this minimum power threshold (e.g., by outputting control signals to switch components on power stage circuit 104 at a non-zero drive frequency); and to calculate (e.g., determine, compute) a maximum power point for the photovoltaic cell 102 for current environmental conditions (e.g., lighting, temperature). This maximum power point (or “MPP”) represents an output voltage and output current of the photovoltaic cell 102 at which the photovoltaic cell 102 outputs the maximum possible power under current environmental conditions, such as lighting conditions and/or incident light intensity, temperature of the photovoltaic cell etc. By continuously operating the photovoltaic cell 102 at its maximum power point, the controller 106 enables the photovoltaic cell 102 to achieve high power conversion efficiency between incident electromagnetic radiation and electrical power output to the power stage circuit 106.

The controller 106 can maintain the power stage circuit 104 in the idle mode while the device is in very low-light conditions in order to prevent unnecessary power consumption at the power stage circuit 104 and/or the controller 106. For example, the controller 106 can maintain the power stage circuit 104 in idle (e.g., off, low-power) mode while the portable electronic device is located in the user's pocket. However, if the user removes the portable electronic device from her pocket and places it, for example, face down on a surface in typical indoor lighting conditions, the controller 106 can detect an increased voltage, current, and/or power output from the photovoltaic cell 102 as a result of the increased environmental light intensity. The controller 106 is therefore configured to sample the output of the photovoltaic cell 102 either continuously or periodically (e.g., once every few seconds, once per second, once per millisecond), even while maintaining the power stage circuit 104 in the idle mode. Under indoor lighting conditions (e.g., 100-1000 lux), the power output of the photovoltaic cell 102 typically exceeds the minimum power threshold required for positive energy efficiency. Thus, in response to detecting an output from the photovoltaic cell 102 exceeding the minimum power threshold, the controller 106 can initiate output control (e.g., gate drive) signals to the power stage circuit 104 to initiate power conversion between the photovoltaic cell 102 and the portable electronic device's battery or power management system.

When the controller 106 first begins to drive the power stage circuit 104 (i.e., upon initiating power conversion), circuit components such as capacitors and inductors within the power stage circuit 104 may experience significant voltage and/or current spikes. These circuit components are particularly sensitive to excess voltage and current due to the small component dimensions required for integration of the system 100 into, for example, a smartphone. The controller 106 is therefore configured to load capacitors in the power stage circuit 104 to a stable, low voltage (e.g., from the phone's battery) shortly before or immediately following initialization of the power conversion circuit. Thus, power stage circuit 104 can produce an optimal low-voltage output with minimal risk of potentially damaging voltage spikes on its capacitor components. The controller 106 can be further configured to steadily increase the drive frequency of control signals output to switches on power stage circuit 104 in order to reduce the risk of circuit component (e.g., inductor) failure due to excess current and/or voltage when initializing power conversion. In particular, the controller 106 may ramp up the drive frequency from zero to a selected and/or calculated operational drive frequency for the given lighting conditions (e.g., 400 kHz for indoor lighting) over a certain period of time, or over a certain number of duty cycles in order to reduce the load on capacitors, inductors and/or other components of the power stage circuit 104.

The controller 106 is further configured to calculate (e.g., determine, compute, interpolate) a maximum power point of the photovoltaic cell 102 upon initializing power conversion at the power stage circuit 104. The power conversion efficiency of the photovoltaic cell 102 can vary widely under different lighting conditions when outputting at free-running voltage and current levels (which can also vary widely). The controller 106 is therefore configured to implement one or more maximum power point tracking (or “MPPT”) algorithms by recruiting switches, resistors, and/or other components of the power stage circuit 104 in order to identify an output voltage and an output current (i.e. load characteristics) at which the photovoltaic cell 102 produces maximum power under current lighting conditions. In particular, the controller 106 performs iterative load (i.e., impedance) matching between the photovoltaic cell 102 and the device's battery (e.g., a 5V phone battery) over a number of duty cycles by successively increasing and/or decreasing the resistance between the photovoltaic cell 102 and the power storage device until the controller identifies a maximum power point. In one implementation, the controller 106 can be an FPGA or other microcontroller configured to implement maximum power point tracking on the power stage circuit 104 by outputting dummy (i.e., false) voltage and current data to the power stage inputs. Alternatively, the controller 106 and the power stage circuit 104 can be integrated into a single ASIC configured for on-board implementation of MPPT algorithms. In particular, maximum power point tracking can be implemented using a perturb and observe method, an incremental conductance method, a current sweep method, a constant voltage method, or any other suitable method to calculate optimal load characteristics for maximum power conversion efficiency.

The controller 106 is configured to continuously implement maximum power point tracking during power conversion at a fixed or configurable duty cycle frequency (e.g., 15 Hz) and to adjust the load characteristics of the photovoltaic cell 102 accordingly, thereby maintaining a high power conversion efficiency of the photovoltaic cell 102 throughout frequent, rapid changes in external lighting conditions. In one variation, the controller 106 can execute a maximum power point tracking algorithm at a much higher cycle frequency (e.g., up to 1 kHz) to quickly calculate optimum load characteristics when initiating power conversion at the power stage circuit 104 (e.g., when the user removes the device from her pocket or bag). The controller 106 can then reduce the duty cycle frequency (e.g., to a default or steady state frequency) after the controller determines a maximum power point for the photovoltaic array 102. Even during steady-state power conversion (i.e., subsequent to initiating power conversion at the power stage circuit 104), the period between MPPT cycles is short relative to typical speeds of transient lighting changes, extending these lighting changes over multiple (e.g., many) control cycles. The controller 106 can therefore continuously adjust load characteristics of the photovoltaic cell's output to match changes in maximum power point that can occur during sudden changes in lighting conditions. For example, if the user reaches for her portable electronic device (e.g., located on her desk), the photovoltaic array 102 may receive less and less incident light, and finally may become partially covered by her hand. Even when operating at default MPPT cycle frequency, the controller 106 can calculate a new maximum power point multiple times during this lighting transition (which may occur, for example, over the course of less than a second) and adjust the load characteristics of the photovoltaic cell 102 accordingly. Thus, the controller 106 can continuously operate the photovoltaic cell 102 at maximum power point even during abrupt changes in environmental conditions in order to maintain high power conversion efficiency.

### 6. Gate Driver and Frequency Optimization

The blocks of the method S100 recite, in response to determining that the maximum power point is consistent with a first lighting condition, outputting gate control signals to the power stage circuit 104 at a first frequency in Block S140A. In response to determining that the maximum power point is consistent with a second lighting condition the controller can: output gate control signals to the power stage circuit 104 at a second frequency greater than the first frequency in Block S140B. Generally, the controller 106 is configured to: calculate and/or select a configurable drive frequency of gate control signals output to power stage circuit 104 based on the current maximum power point of the photovoltaic cell 102; and to adjust the drive frequency in response changes in the maximum power point. In particular, the controller 106 can select a lower drive frequency (e.g., 200-600 kHz, 2 MHz-20 Mhz) if the current maximum power point of the photovoltaic cell 102 is consistent with low light conditions (e.g., indoor lighting). Alternatively, the controller 106 can select a high drive frequency (e.g., 1-2 MHz, 50 MHz-100 MHz) if the current maximum power point of the photovoltaic cell 102 is consistent with strong lighting conditions (e.g., outdoor lighting in full sun). The controller 106 is further configured to adjust the frequency of gate drive signals output to the power stage circuit 104 in response to detecting a significant change in the maximum power point and/or output power of the photovoltaic cell 102 (e.g., due to a change in lighting). Because the high frequency of both gate drive signals and MPPT cycles, transient lighting changes are extended over many control cycles, thereby enabling controller 106 to adapt the drive frequency of gate control signals output to the power stage circuit 104 under changing lighting conditions in near-real time.

If the user's portable electronic device is face down on her indoor desk (i.e., so that the photovoltaic cell faces upward and receives incident indoor light), the controller 106 can operate the photovoltaic array 102 at a maximum power point (i.e., output voltage and current) consistent with a low incident light intensity. Because the electrical power produced by the photovoltaic array 102 is relatively low under these conditions (e.g., relative to strong outdoor light intensities), the controller 106 is configured to output gate drive signals to the power stage circuit 104 at a frequency on the lower end of its configurable frequency range (e.g., 200-800 kHz, 2 MHz-20 MHz). At lower drive frequency, inductor elements and/or other circuit components on power stage circuit experience a larger current load than under a higher drive frequency, given the same output from the photovoltaic cell. Under indoor lighting conditions, however, photovoltaic array 102 produces a relatively low output power. Thus, controller 106 can safely drive power stage circuit 104 at a low switching frequency in low light environments without damaging circuit components on the power stage (e.g., due to excess current). Therefore, when operating photovoltaic cell 102 at a maximum power point consistent with indoor lighting conditions, controller 106 is configured to select and/or calculate a lower optimal driving frequency in order to minimize power losses incurred by switching at gate components (e.g., FETs) in power stage circuit 106, thereby increasing the overall efficiency of power conversion between photovoltaic cell 102 and the device's battery.

When integrated with a smartphone or other portable electronic device, the photovoltaic cell 102 can experience rapid changes in lighting conditions (e.g., incident light intensity). For example, when the user picks up the portable electronic device off her desk, her hand may shade a substantial portion of the photovoltaic cell 102 and reduce the overall intensity of light incident upon the photovoltaic cell 102. Because the controller 106 is configured to implement MPPT at a high duty cycle frequency (e.g., 15 Hz or more), the controller 106 can rapidly determine (e.g., compute, calculate, interpolate) a new maximum power point of the photovoltaic cell 102 corresponding to this partially-shaded condition. Subsequently and/or concurrently, the controller 106 can reduce the frequency of gate drive signals output to the power stage circuit 104 (e.g., in response to and/or due to operating photovoltaic cell 102 at a lower MPP). In one implementation, the controller 106 can determine and/or select a lower frequency value corresponding to the new maximum power point and continuously reduce the drive frequency until this value is attained (e.g., over the period of a single MPPT cycle). In another implementation, the controller 106 is configured to maintain the current drive frequency for a number of consecutive MPPT cycles, and to subsequently determine a new optimal frequency value and adjust the drive frequency accordingly (e.g., after the controller has stabilized the photovoltaic cell 102 at a new MPP). Due to the high frequency of MPPT cycles, the controller 106 can execute Blocks S130-S140 of the method S100 several times per second, and therefore can continuously adjust load characteristics of the photovoltaic cell 102 and gate drive frequency in response to transient changes in lighting condition. For example, the controller 106 may adjust the output voltage and/or current and reduce the frequency of gate drive signals several times as a user reaches for the phone and picks it up off her desk (i.e., as photovoltaic array 102 becomes increasingly shaded and then partially covered by the user's hand).

Likewise, the controller 106 is configured to increase the frequency of gate control (e.g., drive) signals output to the power stage circuit 104 in response to increases in incident light intensity. For example, if the user is holding the portable electronic device with integrated system 100 and carries it outside, the overall intensity of light (and thus the power output of the photovoltaic array 102) may quickly become several times greater than under indoor conditions. The controller 106 can therefore calculate and/or select a higher switching frequency (e.g., >1 MHz, >50 MHz) at which to output gate control signals to the power stage circuit 104 and increase the drive frequency accordingly, thereby reducing the total current within inductors and other circuit components on the power stage circuit 104 in order to offset the increased electrical load output from the photovoltaic cell 102. While driving gates (e.g., FETs) on the power stage circuit 104 at higher frequency can incur larger power losses due to switching, the amount of power dissipated by switching losses is substantially less than the power converted by the photovoltaic cell 102 in strong (e.g., outdoor) light, enabling the system 100 to significantly charge a power storage unit on a portable electronic device. Due to the high frequency of MPPT cycles, the controller 106 can match the load characteristics of the photovoltaic cell 102 to a new maximum power point and concurrently and/or subsequently increase the gate drive frequency several times while the device is brought into the stronger lighting condition. By quickly increasing the drive frequency in this manner, controller 106 can significantly reduce the risk of faults or failure in the small form-factor power stage components due to excess current from the photovoltaic cell.

Moreover, by frequently adjusting load characteristics of the photovoltaic cell in response to changes in maximum power point and adjusting gate drive frequency as described above, controller 106 can substantially increase both the efficiency of power conversion at photovoltaic cell 102 and the efficiency of power transfer to the battery at power stage circuit 104 under transient lighting changes while protecting the small power stage circuit components from over-voltage and/or over-current faults.

### 7. Cell Chemistries

Photovoltaic cell 102 includes a layer of flexible photovoltaic (e.g., semiconducting) material, at which absorption of incident photons displaces charge carriers which are then captured as electric current. In one variation, the photovoltaic material is crystalline silicon, which can be separated into two layers and doped (e.g., with boron and phosphorus) in order to increase power conversion efficiency of the photovoltaic cell. In one example, the photovoltaic material is monocrystalline silicon (mono-Si). In another example, the photovoltaic material is polycrystalline (multi-Si) silicon, which can also, for example, be grown on a mono-Si seed wafer to form an epitaxial wafer. Silicon cells can make system 100 less expensive to manufacture but generally have a lower power conversion efficiency than other, more expensive photovoltaic materials.

In another variation, the photovoltaic material of photovoltaic cell 102 is a thin film material such as cadmium telluride, gallium arsenide, or copper indium gallium selenide. These thin film materials exhibit a substantially higher power conversion efficiency than silicon cells, but are typically more costly to produce and/or manufacture.

In yet another variation, the photovoltaic material of photovoltaic cell 102 is a Perovskite structured compound such as a hybrid organic-inorganic lead material or tin halide material. Perovskite materials can achieve a suitable power conversion efficiency at relatively low manufacturing cost. Moreover, Perovskite materials are semi-transparent. Thus, a perovskite cell can be arranged over with a silicon cell or thin-film cell to form a tandem cell in order to further increase power conversion efficiency, as described in more detail below.

These examples, however, are merely illustrative. One of ordinary skill in the art would recognize that photovoltaic cell 102 can include any suitable photovoltaic material or combinations of photovoltaic materials without departing from the scope of the present invention.

### 8. Multi-Cell Systems

In one variation, the system includes a set of (e.g., multiple) photovoltaic cells arranged into a photovoltaic array. Each photovoltaic cell in the set of photovoltaic cells can be affixed separately to a flexible PCB layer such as flexible PCB layer 108. Together, the set of photovoltaic cells covers a majority of the upper surface area of flexible PCB layer 108. In one implementation, system 100 includes a set of (e.g., multiple) power stage circuits similar to power stage circuit 104, each of which is electrically coupled to a corresponding photovoltaic cell in the photovoltaic array through electrical traces in the flexible PCB layer and electrically coupled to an external power storage device or battery. In this implementation, each power stage circuit in the set of power stage circuits is coupled to a single controller configured to execute method S100. Together, the set of power stage circuits and the controller are configured to convert power harvested by each photovoltaic cell in the photovoltaic array and concurrently or sequentially output power harvested by each cell to an external power storage device. For example, the controller can output gate drive signals to a first power stage circuit to convert power at a first photovoltaic cell in the array at a first time, and subsequently output gate drive signals to a second power stage circuit to convert power at a second photovoltaic cell in the array at a second time succeeding the first time. In one implementation, the controller can drive the first power stage circuit at a first frequency based on the current maximum power point of the first photovoltaic cell, and drive the second power stage circuit at a different frequency in response to determining that the maximum power point of the second photovoltaic cell differs significantly from that of the first cell, thereby minimizing overall switching losses across the set of power stage circuits. Alternatively, the controller can be configured to output gate drive to each power stage circuit concurrently (e.g., at the same frequency) to convert power at all photovoltaic cells in the array simultaneously.

In one implementation, each photovoltaic cell in the photovoltaic array includes the same photovoltaic material (e.g., each cell is a silicon cell, each cell is a thin film cell). In another implementation, one or more cells in the photovoltaic array include a first photovoltaic material (e.g., silicon), while other cells in the photovoltaic array include a different photovoltaic material (e.g., a thin film material, a perovskite material). For example, when the system is integrated with a smartphone, photovoltaic cells located on the lower portion of the phone casing (which are more likely to be shaded and/or covered by a user's hand) can include a lower efficiency photovoltaic material such as silicon, while photovoltaic cells located on the upper portion of the phone casing (which are more likely to receive unobstructed light) can include a higher efficiency material such as gallium arsenide or other thin film material. In another example, the photovoltaic array can include a semi-transparent perovskite cell arranged over a set of silicon and/or thin-film cells to form a tandem array. In this implementation, the perovskite cell can harvest power from incident light normally, while the bottom photovoltaic cell(s) can harvest power from light transmitted through the perovskite cell, thereby enabling the photovoltaic array to achieve a higher power conversion efficiency than a single-cell system.

In this implementation, the maximum power point of a photovoltaic cell at one location in the photovoltaic array can differ significantly from the maximum power point of a photovoltaic cell at a different location on the array under certain lighting conditions (e.g., if the array is partially shaded or covered). The controller can therefore be configured to calculate a maximum power point for each photovoltaic cell in the array, and to adjust the load characteristics (e.g., output voltage and output current) of each individual cell to match its respective maximum power point. In one implementation, the controller is configured to implement maximum power tracking (i.e., load matching) for a first photovoltaic cell in the array over a first series of duty cycles, and to subsequently implement maximum power point tracking for a second photovoltaic cell in the array over a subsequent series of duty cycles, repeating this process cyclically for each cell in the array. The controller can therefore operate each photovoltaic cell in the array at or near its particular maximum power point throughout the power conversion process, which can significantly improve the overall power conversion efficiency of the array relative to that of a single cell system under mixed (i.e., partially shaded) lighting conditions.

### 9. Heat Transfer

When integrated into a portable electronic device such as a smartphone, system 100 can become a thermal interface between the device (e.g., battery and other components) and its external environment. On one hand, photovoltaic cell 102 absorbs a portion of infrared radiation from incident light and can therefore slow the rate radiation heating of the device's battery (e.g., from direct sunlight). On the other hand, integration of system 100 can affect normal convective cooling of the device (e.g., through the back of the phone). Therefore, flexible PCB layer can include a set of thermal vias to draw heat from the backing of the portable electronic device out to its edges in order to facilitate convective cooling. The thermal vias on flexible PCB layer 108 can also transfer heat generated by operation of power stage circuit 104 and controller 106 out to the edges of the portable electronic device in order to reduce resistances between the source and drain terminals of switch components (e.g., FETs) in these circuits, thereby increasing power conversion efficiency. In one implementation, controller 106 is configured to detect that the portable electronic device has been in direct sunlight for an extended period of time (e.g., based on power output and/or maximum power point of photovoltaic cell 102) and cause the device to issue a visual, audible, and/or haptic notification to the user prompting her to move the device in order to prevent excess radiation heating of the device's battery.

### 10. Other Devices

While the examples above mostly relate to system 100 integrated into the backing of a smartphone, the system 100 can be integrated into the casing of any other suitably sized electronic device. In one example, the system 100 can be integrated into, assembled over, or deposited on the casing of a laptop computer (e.g., on the back of the screen and/or around C-side components). In another example, the system 100 can be integrated into, assembled over, or deposited on the side casing and/or wristband of a smartwatch. In yet another example, the system 100 can be integrated into, assembled over, or deposited on the backing of a tablet computer.

Alternatively and/or additionally, the system 100 can be integrated into, assembled over, or deposited on a phone or laptop case and electrically coupled to the device's battery (e.g., by way of a conventional charging port).

Alternatively and/or additionally, the system 100 can be integrated into, assembled under, or deposited under a transparent OLED display (TOLED), which virtually transparent when the display is off. In this variation, the TOLED display transmits a substantial portion of incident light to the photovoltaic cell when the device is powered off or in a sleep (e.g., idle mode).

These examples, however, are merely illustrative. One of ordinary skill in the art would recognize that the system can be integrated into any suitable electronic device without departing from the scope the present invention.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system, comprising:
a power storage device;
a flexible PCB layer;
a photovoltaic cell arranged over the flexible PCB layer; and
a power conversion circuit arranged underneath the flexible PCB layer, comprising:
a power stage circuit electrically coupled to the photovoltaic array and to the power storage device through the flexible PCB layer; and
a controller electrically coupled to the power stage circuit through the flexible PCB layer and configured to:
measure a power output from the photovoltaic array;
operate the power stage circuit in an idle mode in response to determining that the power output does not exceed a threshold power output; and
in response to determining that the power out exceeds the threshold power output:
calculate a maximum power point of the photovoltaic array;
in response to determining that the maximum power point is consistent with a first lighting condition:
output gate control signals to the power stage circuit at a first frequency; and
in response to determining that the maximum power point is consistent with a second lighting condition:
output gate control signals to the power stage circuit at a second frequency that is higher than the first frequency.
